(19) United States
(12) Patent Application Publication
(10) Pub. No.: US 2025/0139725 A1
(43) Pub. Date: May 1, 2025

(54) PERSONAL SECURITY ASSISTANT SYSTEM

(71) Applicant: iGOTCHU HELP Inc., Wilmington, DE (US)

(72) Inventors: Seven Achilles Evans, LAS VEGAS, NV (US); IYKE ARINZE AKPAMGBO, Encino, CA (US)

(21) Appl. No.: 18/600,123

(22) Filed: Mar. 8, 2024

Related U.S. Application Data
(60) Provisional application No. 63/594,041, filed on Oct. 30, 2023.

(51) Int. Cl. G06Q 50/26; G06Q 10/1053

(52) U.S. Cl. CPC G06Q 50/265; G06Q 10/1053

(57) ABSTRACT

A system and method for providing customized security to cater to different security needs of a people. The system makes private security accessible and affordable to many in society. The system includes an interface configured to allow a service seeker and a service provider to interact with each other. The interface includes a hire screen that is split into an upper section and lower section. The upper section has a map, and the lower section presents a profile of a contractor or service provider. Current locations of the service seeker and provider are presented on the map. Also, the system provides a personal digital assistant implemented on a home security device that allows audio and video telephony with a visitor.

### CROSS-REFERENCE TO RELATED APPLICATIONS

This application claims priority from a U.S. provisional patent application Ser. No. 63/594,041, filed on Oct. 30, 2023, which is incorporated herein by reference in its entirety.

### FIELD OF INVENTION

The present invention relates to a security assistance system, and more particularly, the present invention relates to a system that provides personalized security solutions.

### BACKGROUND

Police are a primary organization of society for maintaining public order and safety. Police are entrusted to safeguard the public against crime, violence, misdemeanors, and like crime. The police are responsible for enforcing the law and providing support in society. However, to be efficient, police to public ratio in a society would be ideal. However, maintaining this ideal ratio is costly and a society often lacks resources to maintain a large police force.

The private security industry tends to fill the gap created by the lack of police officers in society. Private security guards can be ex-police officers, ex-army officers, ex-navy seals, and trained people. There are several agencies responsible for the training, certification, and recruitment of private security guards or personnel. However, in the present system, hiring private security personnel is a costly and time-consuming process. Only a few in society can afford private security.

A need is therefore appreciated for a system and method that can overcome the previously mentioned drawbacks.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system for providing customized and personalized security solutions.

It is another object of the present invention that the system can cater to different security needs of a society.

It is still another object of the present invention that the system can cater to urgent security needs.

It is still another object of the present invention that the system makes the process of hiring easier and more economical.

It is yet another object of the present invention that the system provides for enhanced personal safety offering a sense of security and peace of mind, reducing the concerns about becoming victims of violent crimes, regardless of social or economic status.

A further object of the present invention is that the system caters to the affordable security needs of society.

Still, a further object of the present invention is that the system may provide immediate assistance in the event of an emergency or feeling threatened.

An additional object of the present invention is that the system allows for real-time location sharing with trusted individuals, allowing loved ones to keep track of their whereabouts.

Still, an additional object of the present invention is that the system may help reduce crime.

In one aspect, disclosed is a personal security assistance system comprising a processor and a memory, the personal security assistance system is configured to implement a method comprising registering a first user and a second user, wherein the first user is a seeker of a service, and the second user is a provider of the service; and presenting an interface on a first user device and a second user device, wherein the interface is configured to allow the first user and the second user to interact with each other. The interface comprises a hire screen presented on the first user device, the hire screen is split into an upper map screen and a lower info screen, the upper map screen comprises a geographical dynamic map, and the lower info screen is configured to present a profile of the second user, the profile comprises a photograph, name, and brief description about the user, the lower screen further comprises one or more action buttons. The method further comprises determining current locations of the first user and the second user in near real-time using GPS technology; overlaying, the current locations of the first user and the second user on the geographical dynamic map; and updating the geographical dynamic map with changes in the current locations of the first user and the second user.

In one aspect, the personal security assistance system further comprises determining a travel distance between the first user and the second user, in near real-time; determining an estimated time of arrival of the second user to the current location of the first user; and displaying the estimated time of arrival on the lower info screen. The method further comprises registering one or more other users, wherein the one or more other users are service providers; and wherein the current locations of the one or more other users are also displayed on the geographical dynamic map. The method further comprises presenting icons adjacent to each of the current locations of the respective users on the geographical dynamic map, wherein the icons are dynamically linked to a profile of the respective user, wherein clicking the icon results in opening of a profile of a respective user.

The hire screen is configured to allow the first user to telecall, video call, and chat with the second user. The service comprises security services. The method further comprises receiving an emergency call from the first user device; upon receiving the emergency call, activating a camera and a mic on the first user device; and upon activating, receiving an audio and video of surroundings of the first user device. The method further comprises implementing a personal digital assistant on a home security device of the first user, wherein the home security device is configured to provide a video telephonic call of the first user device with a visitor.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIG. 3 is a main screen or dashboard of the interface provided by the system, according to an exemplary embodiment of the present invention.

FIG. 4 is a hiring screen of the interface provided by the system, according to an exemplary embodiment of the present invention.

FIG. 5 shows a home device with a personal digital assistant, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, systems, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for providing customized security to cater to different security needs of a people. The disclosed system makes private security accessible and affordable to many in society. The disclosed system can help create more jobs. Moreover, the disclosed system may provide personalized security solutions.

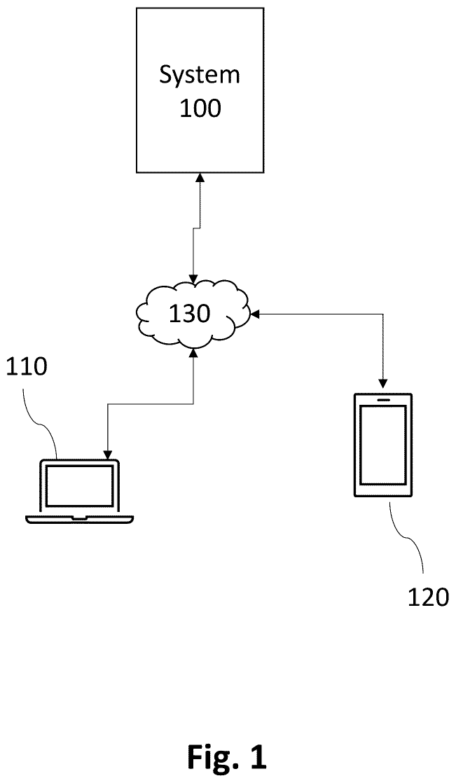

Referring to FIG. 1 which shows an exemplary embodiment of the present invention. The disclosed system can connect to an offeror device. The offeror can be any person or organization offering a service or willing to offer a service. The offeror is also referred to herein as a service provider or contractor. The service can be concierge service, chaperone service, digital assistance service, security service, protective service, and the like. The offeror device can be a smartphone, a computer, a laptop, a workstation, a desktop, and the like. The offeror device can connect with the system through a network.

The network can be wired, a wireless network, or may include a combination of wired and wireless networks. For example, the network may be a local area network (LAN), a wide area network (WAN), a wireless WAN, a wireless LAN (WLAN), a metropolitan area network (MAN), a wireless MAN network, a cellular data network, a cellular voice network, the Internet, etc. The drawing shows a single network for illustration only, it is understood that the different devices can connect through different networks. Moreover, a single device can connect through different networks.

The system can also connect to a client device. The client can be any person seeking any of the above services or availing any of the above services. The client device can be a smartphone, a computer, a laptop, a workstation, a desktop, and the like. The client device can connect to the system through a suitable network.

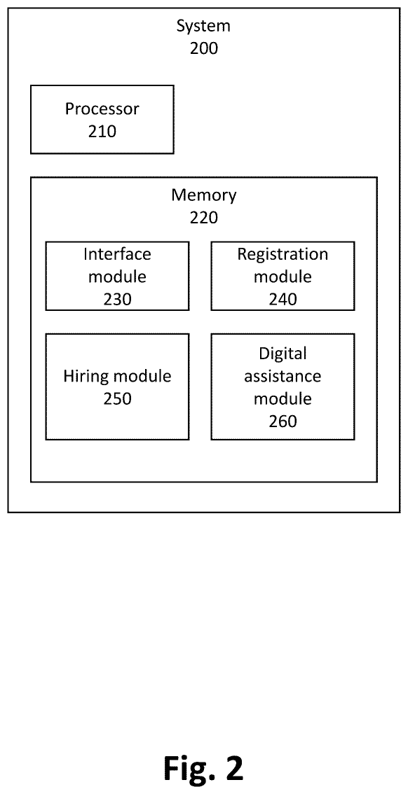

Referring to FIG. 2 which shows an exemplary embodiment of the present invention. The system includes a processor and a memory. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The memory may include an interface module, a registration module, a hiring module, and a digital assistance module. The interface module upon execution by the processor can present an interface on the client device and the offeror device. Through the interface, a user may interact with the disclosed system. The user can be a service provider or a client, and the term “user” as used herein, and throughout this disclosure, refers to an individual engaging a device according to embodiments of the invention. The system may be implemented using one or more servers, the servers include cloud servers. Also, one or more servers may be located at one location or geographically dispersed. Also, it is understood that different steps of the disclosed methodology may be performed on multiple servers without departing from the scope of the present invention. Also, one or more steps of the disclosed methodology may be performed on the user device without departing from the scope of the present invention.

The memory may also include a registration module, wherein the registration module upon execution by the processor may perform one or more functions of the disclosed methodology. The registration module may allow a user to register with the disclosed system. The memory may also include a hiring module, wherein the hiring module upon execution by the processor may perform one or more functions of the disclosed methodology. The hiring module may allow a client to hire a service provider for any of the available services. The memory may also include a digital assistance module, wherein the digital assistance module upon execution by the processor may perform one or more functions of the disclosed methodology. The digital assistance module may provide digital assistance on the user device.

The interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the worldwide web. The application software can also be provided for the desktop environment, such as Windows™, Linux, and macOS. The user interface may permit interaction with a user through the user device, wherein information can be presented within the user interface by system 100 and information can be received by system 100 from the user.

The registration module may allow registering with the disclosed system, the user can register as a service provider or as a client. The registration module may provide an interface to receive information about the user. For a service provider, the interface may allow listing services on the disclosed system. The interface may provide the type of services, wherein the user can select the services and provide availability. The registration module may also obtain from the service provider information such as training, certification, and the like. Such information can be later used to verify the identity and skills of the service provider.

The registration module may also allow a service provider to register their devices, wherein the registered devices can be tracked by the system using GPS or like functionality. The registration module can also provide login credentials to the registered users, wherein the login credentials may allow the user to log into the system securely. Communication with the system may also be encrypted using suitable algorithms as an additional security layer. It is understood that the system may incorporate any of the available security protocols to secure communication between the user devices and the system, and any such security protocol is within the scope of the present invention. Moreover, the login credentials may include a passcode, biometric login, and the like known to a skilled person for gaining secure access to a system.

The registration module may input certain information from the user, such as name, address, email address, phone number, and the like. The registration module may also obtain a picture of the user. The registration module using the information can create a profile of the user. The user may be allowed to later modify their profile or some parts of the profile. The service providers can edit the listed services including their availability.

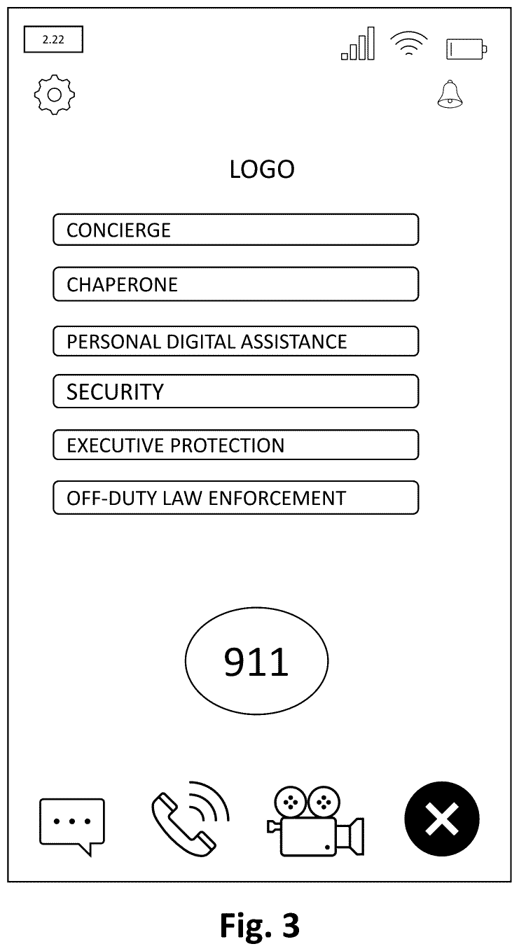

The hiring module may allow users to hire service providers, contractors, and the like for any of the listed services. The hiring module may provide an interface as shown in FIG. 3. The screen shown in FIG. 3 includes different categories of services, for example, concierge, chaperone, robot/AI security, security, executive protection, and off-duty law enforcement. The user may select any category based on requirement. For example, a user seeking concierge service can click the soft button of CONCIERGE. The screen also has options for an emergency call, such as 911 service in the U.S.A. On the top corner of the screen is a setting icon that allows a user to adjust the settings. On the right corner can be a bell icon that opens notifications. In the lower portion of the screen can be a menu bar that includes a chat icon, a call icon, a video call option, and a cancel option.

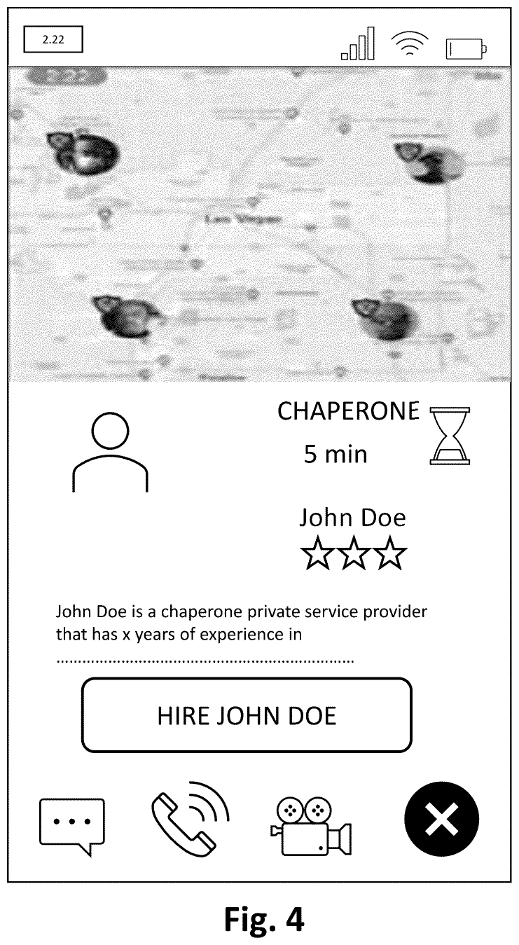

Based on a selection of service categories by the user, the hiring module can present a new screen. One example of such a screen is shown in FIG. 4. This screen is referred to as a hire screen. The hire screen lists all the available service provider options that may be suitable for the user. The screen can be split into two sections, wherein the upper section shows a map, and the lower section shows the details of the service provider. The map shows the current location and nearby service providers. An icon can be shown for the service provider on the map. the icon can be dynamic, wherein the user can click on the icon, and details of the respective contractor can be displayed in the lower section. The map can show the distance of service providers from the current location of the user and the time of arrival of the service providers to the current location.

The user can check the profile of desired service providers by clicking the respective icons. The profile may include a brief description of the contractor and its rating. An option to hire the contractor can also be provided on the hire screen. Before or after hiring a contractor, the user can be provided with options to check the profile of the respective contractors, their experience, skills, past reviews, certifications, and the like. The user can also call the contractor or chat, anytime. The menu bar includes the options to call including video call and chat.

The user may also have an option to expand a section, such as the map can be expanded to full screen. Similarly, the info section can be expanded to a full screen. The user can track, in real-time, the contractor, and the contractor can track the user.

Once hired, the system may also allow the user to pay the fee. For example, a payment screen can be presented to the user through which the user can pay the contractor. It is understood that the user pays to the system and the system can pay the contractor.

The advantage of the disclosed system is that the service providers can register with the system and find clients, thus generating more employment opportunities for the service providers. The system allows the service providers to directly seek clients, thus saving the cost of intermediaries. Moreover, the service providers can find clients locally. Clients on the other hand can get customized solutions. For example, a parent may need protective security while dropping a child at the school, i.e., for a few hours, and could get the same through the disclosed system. Similarly, a businessman may need protective security for a few hours while collecting payment or depositing the payment in the bank. The user can get the desired service within a few minutes through locally available contractors. The user can select the contractors nearest to them for urgent requirements. The user may also have an option to book in advance. However, getting quick and customized service for the desired duration is a chief advantage of the disclosed system.

The “CONCIERGE” service is great when an elite professional is needed for booking hotels, dinners, getting VIP, or just greeting guests at home events. The user may have multiple options nearby through the disclosed system.

The “CHAPERONE” service is great for parents who may want to have a chaperone for their kids when they go out or when just need a person to walk them to their car when they are leaving a bar or club. The Chaperone can also be used to walk a child to school or even take a dog for a walk alone or with the owner of the dog.

The “SECURITY” service dispatches either a plain-clothed armed/unarmed security specialist or a uniformed armed/unarmed security specialist within minutes of the request. Security Specialists can be licensed and bonded/insured. A user can choose the desired contractor based on time, cost, and many other parameters.

The EXECUTIVE PROTECTION (EP) service dispatches a fully licensed and bonded/insured, armed, or unarmed (based on preference) Security Executive Protection Specialist. The security personnel can be highly experienced and thus, such a service can be a top-tier service.

The system may also provide for the OFF-DUTY LAW ENFORCEMENT contractors that include off-duty law enforcement from every law enforcement agency including police, sheriff, highway patrol, ATF, DEA, FBI, Secret Service, etc. for that town, city, county, and state. This service provider includes specialists who are sworn officers, deputy, detective, or other agent that has the power to detain and/or arrest.

The 911 service can be provided through the system, as the user may not have to dial multiple places in urgent situations. The disclosed system can cater to any emergency by using automated and machine learning-based actions. The system can provide additional functionality that may not be available with existing emergency response systems, such as video calls, live chat, real-time tracking, and the like.

For example, there may be a time when a person requesting 911 service may not be able to communicate fast enough or even clearly enough to get HELP quickly. The disclosed system allows the same with just a click of a button or saying a predefined code in their user device. A blind or hearing-impaired person can now get that HELP more quickly just by saying the predefined phrase. The system can detect the trigger i.e., request for emergency services, and call for help autonomously. The system through the user device may also allow capturing audio and video of the surroundings for understanding the situation and taking better actions. The triggering phrase can be a prayer, song, and the like. Once triggered, the user device may become the eye and ear getting all details of the surroundings. The system using machine learning models can handle such input for getting necessary help.

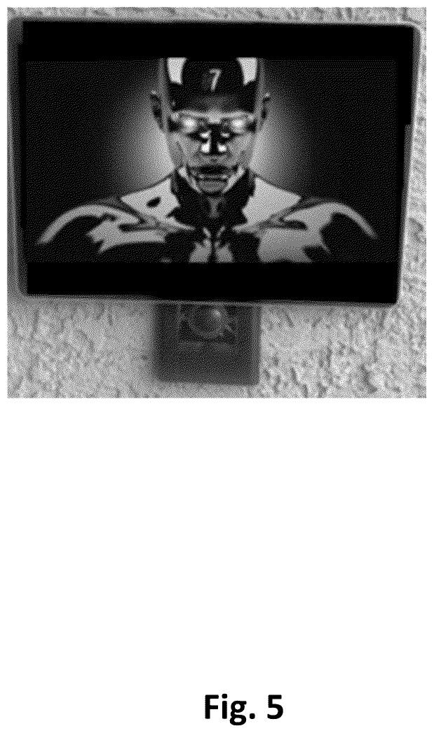

Referring to FIG. 5 which shows a monitor of a video doorbell. The system may also include a personal digital assistant that can be implemented on a user device such as a smartphone, monitor, and the like. The personal digital assistant can help a user thwart any theft, misdemeanor, and the like. The personal digital assistant may provide an interface that on the user's device may help thwart theft, robbery, and the like incidents. The personal digital assistant may guide a user to secure premises. The personal digital assistant by using machine learning modules can identify known and unknown persons, potential threats, and the like.

An avatar can be displayed on the user device, which may resemble the face of a human while speaking. The avatar can be a part of the personal digital assistant. The avatar can be of a user, and it may be projected that a user is talking through video calling. The avatar can also resemble a robot, a celebrity, a police officer, and the like. Thus, while broadcasting the voice through the outdoor unit, the avatar can mimic the facial expressions of a human. Besides the avatar, the personal digital assistant can also mix background voices with the voice of the speaker. These voices appear to a listener if coming from the background of the house owner. Examples of such voices include many people speaking to one another giving an expression that too many people are inside the house. This may be useful for adults or children alone at home, and the thief outside the house gets an expression that many people are inside, this may deter the thief from entering the house. Another useful background noise can be a dog barking. Any person with wrong intentions upon hearing the voraciously growling/barking leaves. The system may also capture through suitable sensors, such as cameras and motion sensors, the presence of an unknown person(s) outside a house. The system upon detecting the presence may play the dog barking/growling sound. In case, the unknown person has a wrong intention, the presence of a dog may cause him to go away.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A personal security assistance system comprising a processor and a memory, the personal security assistance system is configured to implement a method comprising:
registering a first user and a second user, wherein the first user is a seeker of a service, and the second user is a provider of the service;
rendering an interface on a first user device and a second user device, wherein the interface is configured to allow the first user and the second user to interact with each other, wherein the interface comprises:
a hire screen rendered on the first user device, the hire screen is split into an upper map screen and a lower info screen,
the upper map screen comprises a geographical dynamic map, and
the lower info screen is configured to present a profile of the second user, the profile comprises a photograph, name, and brief description about the user, the lower screen further comprises one or more action buttons;
determining current locations of the first user and the second user in near real-time using GPS technology;
overlaying, the current locations of the first user and the second user on the geographical dynamic map; and
updating the geographical dynamic map with changes in the current locations of the first user and the second user,
wherein the system is configured to:
display on the upper map screen, current locations of a plurality of service providers within a predetermined area as a plurality of icons on the upper map screen, the plurality of service providers comprise the second user, wherein the icons are dynamic;
receive a selection of a service provider of the plurality of service providers, the selection is made by clicking the respective icon; and
upon receiving the selection, display information about the selected service provider on the lower info screen.

2. The personal security assistance system according to claim 1, wherein the selected user is the second user, the method further comprises:
determining a travel distance between the first user and the second user, in near real-time;
determining an estimated time of arrival of the second user to the current location of the first user; and
displaying the estimated time of arrival on the lower info screen.

3. (canceled)

4. (canceled)

5. The personal security assistance system according to claim 4, wherein the hire screen is configured to allow the first user to telecall, video call, and chat with the second user.

6. The personal security assistance system according to claim 4, wherein the service comprises security services.

7. The personal security assistance system according to claim 1, wherein the method further comprises:
detecting a trigger for requesting emergency service;
upon receiving the trigger, activating, by the system, a camera and a mic on the first user device;
upon activating, receiving audio and video of immediate surroundings of the first user device by the system; and
analyzing the trigger, the audio, and the video, using machine learning models, to determine an action.

8. The personal security assistance system according to claim 1, wherein the method further comprises:
implementing a personal digital assistant on a home security device of the first user, wherein the home security device is configured to provide a video telephonic call of the first user device with a visitor, wherein the personal digital assistant is configured to:
render an avatar of the first user on a display of the home security device, wherein the avatar simulates the first user talking to the visitor; and
mix background voices with a voice of the first user.

9. A method for providing customized services, the method implemented by a personal security assistance system comprising a processor and a memory, the method comprising:
registering a first user and a second user, wherein the first user is a seeker of a service, and the second user is a provider of the service;
rendering an interface on a first user device and a second user device, wherein the interface is configured to allow the first user and the second user to interact with each other, wherein the interface comprises:
a hire screen rendered on the first user device, the hire screen is split into an upper map screen and a lower info screen,
the upper map screen comprises a geographical dynamic map, and
the lower info screen is configured to present a profile of the second user, the profile comprises a photograph, name, and brief description about the user, the lower screen further comprises one or more action buttons;
determining current locations of the first user and the second user in near real-time using GPS technology;
overlaying, the current locations of the first user and the second user on the geographical dynamic map; and
updating the geographical dynamic map with changes in the current locations of the first user and the second user,
wherein the system is configured to:
display on the upper map screen, current locations of a plurality of service providers within a predetermined area as a plurality of icons on the upper map screen, the plurality of service providers comprise the second user, wherein the icons are dynamic;
receive a selection of a service provider of the plurality of service providers, the selection is made by clicking the respective icon; and
upon receiving the selection, display information about the selected service provider on the lower info screen.

10. The method according to claim 9, wherein the selected user is the second user, the method further comprises:
determining a travel distance between the first user and the second user, in near real-time;
determining an estimated time of arrival of the second user to the current location of the first user; and
displaying the estimated time of arrival on the lower info screen.

11. (canceled)

12. (canceled)

13. The method according to claim 12, wherein the hire screen is configured to allow the first user to telecall, video call, and chat with the second user.

14. The method according to claim 9, wherein the service comprises security services.

15. The method according to claim 9, wherein the method further comprises:
detecting a trigger for requesting emergency service;
upon receiving the trigger, activating, by the system, a camera and a mic on the first user device;
upon activating, receiving audio and video of immediate surroundings of the first user device by the system; and
analyzing the trigger, the audio, and the video, using machine learning models, to determine an action.

16. The method according to claim 9, wherein the method further comprises:
implementing a personal digital assistant on a home security device of the first user, wherein the home security device is configured to provide a video telephonic call of the first user device with a visitor, wherein the personal digital assistant is configured to:
render an avatar of the first user on a display of the home security device, wherein the avatar simulates the first user talking to the visitor; and
mix background voices with a voice of the first user.

17. The personal security assistance system of claim 1, wherein the upper map screen is configured to be explained replacing the lower info screen, and the lower info screen is configured to be expanded replacing the upper map screen.
